(19) United States
(12) Patent Application Publication
(10) Pub. No.: US 2010/0067039 A1
(43) Pub. Date: Mar. 18, 2010

(54) SYSTEM AND METHOD FOR PROVIDING ADVERTISING TO PRINTERS

(75) Inventor: Michael Robert Williams, Preston (GB)

Correspondence Address: DARBY & DARBY P.C., P.O. BOX 770, Church Street Station, New York, NY, 10008-0770, US

(73) Assignee: Global Graphics Software Limited, Cambridge (GB)

(21) Appl. No.: 12/212,463

(22) Filed: Sep. 17, 2008

(51) Int. Cl. G06Q 30/00; G06F 3/12

(52) U.S. Cl. 358/1.15

(57) ABSTRACT

A system for printing documents includes a printer; a replaceable cartridge coupled to the printer and providing a consumable to the printer for printing the documents; and a printer driver configured and arrange to be disposed on a device coupled to the printer for assisting in providing the documents to the printer. The system is configured and arranged to print or display advertising to a user in conjunction with the printing of documents.

### FIELD

The present invention is directed to the area of printers, printed documents, and printer software and hardware, as well as to methods of printing.

### BACKGROUND

Printer vendors receive revenue from the original sale of the printer itself and from the sale of follow-on consumables. The consumables may be, for example, toner cartridges (for toner-based laser printers), ink cartridges (for ink jet printers), paper (for example, for specialist photo printers), and the like. In this approach the printer is often sold at or below cost as a loss-leader, while much, if not all, of the profit is made on the consumables.

Different vendors may use different approaches in balancing the profitability of each of the printer and consumable components; those who believe that the initial capital cost of the printer provides the strongest persuasion for customers to buy that model tend to charge slightly more for consumables than those who believe that the price per print (based on ink/toner and paper) is the most important factor. The same vendor may also choose different positions on this scale for models aimed at different groups of customers. For example, a printer for home use may have the capital outlay, minimized, while one for use in mid- to large-sized offices may emphasis the cost per print.

This approach has a number of risks associated with it, however. A user may decide to replace their printer with a new one rather than to replace the ink/toner cartridge(s) in his existing one. In many cases a new printer may actually cost less than a full set of cartridges, although this apparent cost-saving may mask the fact that cartridges supplied in new printers often contain only a fraction of the amount of ink or toner in a new regular cartridge.

Another risk is that a user may buy third-party consumables (e.g., cartridges), rather than the printer vendor's own, leaving the vendor with the cost of a loss-leader and no follow-up revenue to compensate. Third-party consumables (e.g., cartridges) are usually cheaper, and are sometimes more widely available. Another form of this is the use of cartridge re-filling kits or of recycled cartridges.

To counteract the latter risk printer vendors have run campaigns claiming that third-party consumables often do not achieve a high quality of print, and may damage the printer itself. Such campaigns have not, however, fully achieved their desired effect.

Some printer vendors have also attempted to apply technical solutions to ensure that their printers can only use their own consumables. Such approaches include embedding electronic chips in each cartridge in such a way that the printer will refuse to use a cartridge that does not have such a chip. The legality of this approach has been questioned in some jurisdictions, amidst claims that it is anti-competitive.

In parallel with these risks, the vendor must also provide a product with competitive functionality, which means that they must continually increase print speed and reliability while maintaining (and, preferably, improving) print quality.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a block diagram of a printing system, according to the invention.

### DETAILED DESCRIPTION

The present invention is directed to the area of printers, printed documents, and printer software and hardware, as well as to methods of printing. In particular, the present invention is directed to providing advertising to a user of the printer on one or more of the following: printed media; a printer display; or the device, such as a computer, that the user employs to send documents to the printer. The advertising can provide an additional source of revenue for a vendor (e.g., a manufacturer, distributor, or retailer) of printers or printer consumables and may limit or reduce the price charged to a consumer for the printer or printer consumables. Accordingly, this may provide an alternative source of income for printer vendors, allowing them to maintain or reduce, or limit the increase in, the price of consumables, while maintaining their revenue stream without a concomitant rise in printer capital costs.

As an example, advertising can be provided in situations where consumables are supplied in modular form, within a casing. For example, it is widely applicable to ink and toner cartridges, but may also be applied where, for instance, paper (or other media) is purchased within a single-use cartridge. Throughout the rest of this description the term “cartridge” will be used to describe all such situations.

In at least some embodiments, the printer vendor enters into an agreement with one or more suppliers of advertising, and receives revenue from those partners in return for displaying or printing those advertisements to the user of the printer. In at least some embodiments, cartridges are supplied with electronics embedded within them (for example, a “chip”) that may be detected by the printer with which they are designed to be used. The electronics in the cartridge, firmware or software in the printer, or the software in the printer driver used to send pages to the printer, or any combination thereof, can be used to provide the advertising to the user. They may also be used, alone or in any combination, to determine, if desired, how often such advertisements are printed or displayed to the user, what advertisements are printed or displayed, and through what medium (e.g., printed media, printer display, computer screen, and the like) the advertisements are printed or displayed.

In at least some embodiments, payments from the suppliers of the advertising to the printer vendor may be tied to cartridge sales. Alternatively, the payments may be a flat fee or a periodic fee. In some embodiments, the printer software/hardware or printer driver may enable the transmission of data regarding how often each advertisement has been displayed or printed to a networked server maintained by the printer vendor or by their partners, and payments may be based on that data.

In at least some embodiments, printed advertising may include tokens or coupons that can be redeemed for discounts or other benefits from the advertiser. Advertising displayed on the user's computer screen may include URLs (including personalized URLs) to allow click-through for more information or additional offers from the advertiser. Printed or displayed advertising may include codes that can be entered into an on-line order form, or the like, to receive discounts on products from the advertiser. The use of printed tokens/coupons, click-through from URLs, or codes for discounts may be used to track campaign effectiveness and to trigger payments from the advertising supplier to the printer vendor.

Advertisements can be displayed or printed using a variety of different methods. A printer or cartridge may support printing or displaying advertisements using only one method or in any combination of methods, including printing or displaying some advertisements using one method and printing or displaying other advertisements using a different method.

As one method of printing advertisements, the advertising is printed on separate sheets of media before, after, or during printing of a document. The printer software, hardware, or printer driver may specify how often such sheets are printed based, for example, on the number of pages (e.g. every 20 pages, 25 pages, 50 pages, or 100 pages) or the number of print jobs (e.g., with every print job or every second, third, fourth, or fifth print job). The printer software, hardware, or printer driver may specify whether advertising pages can only appear at the beginning or end of real print jobs, or be interspersed within the print job. The printer software, hardware, or printer driver may specify whether or not advertising pages can be printed on the back of a page in a real print job when printing in duplex mode.

As another method of printing advertising, the advertising is printed on the same sheet of media as a real page of a print job. The printer software, hardware, or printer driver may specify where on the media the advertising is printed, e.g. as a narrow strip down one side, or at the bottom of a page. The printer software, hardware, or printer driver may specify whether or not low-visibility advertising can overlap real page content, e.g. like a watermark. The printer software, hardware, or printer driver may specify whether or not the printer driver/printer should attempt to scale and position advertising in an “intelligent” way to fit within white space on the page. The printer software, hardware, or printer driver may specify whether additional ‘pages’ of advertising can be included, laid out with real pages of the print job in output performed with “N-Up” options, where multiple pages are imposed together on each sheet. The printer software, hardware, or printer driver may specify whether or not the real page data should be scaled down to allow space for advertising on the same sheet.

As yet another method of printing advertising, the advertising is displayed by the printer driver on the printer display or on the computer from which the print job originated. The printer software, hardware, or printer driver may specify whether the advertising is displayed in the printer configuration dialogs, in an additional dialog that is shown while the job is being printed, or by opening another application, such as a normal web browser, to view a page containing advertising.

As a further method of printing advertising, the advertising is displayed on the printer's user interface. For example, printers and MFPs increasingly include relatively large color screens to communicate to the users when collecting their prints or scanning their documents and the advertisements can be displayed on this screen.

The advertising content itself can be obtained from a variety of sources. For example, advertising content can be downloaded from time to time from a networked server running on behalf of the printer vendor or of a partner of that vendor. The download may be directed to the printer, or to one or more of the computers from which pages are sent to the printer. In at least some embodiments, access past a corporate firewall for the download may be provided by using the same proxy setting used for browsing of web pages.

Another source of advertising content is content included within the printer driver for the printer. Yet another source is advertising content supplied within the chip on the cartridge. A further source is advertising content supplied within the printer firmware or software.

In some embodiments, only one of the sources of advertising content may be used. In other embodiments, multiple, or even all of the, sources of advertising content may be used. In some embodiments, a primary source of advertising content may be used with fall-back provisions for circumstances (e.g., installation environments or network outages) where the primary source of advertising content is blocked or otherwise inaccessible (e.g. because the printer is installed in an environment where no internet or intranet access is possible).

In some embodiments, where advertising content is used that was supplied with the printer driver, printer or cartridge, the advertising may be printed more frequently under such circumstances, with a note printed or displayed alongside the advertisements stating that advertising frequency may be reduced by allowing network access for downloading additional content.

In some embodiments, the advertising is targeted to a particular audience. As an example, the printer model is designed for a particular segment (e.g., home, small business, or large business), and advertising is selected to target users within that segment.

As another example, the regional settings (language, locale, time zone etc) used on the computer that sends documents or pages to the printer is used to filter advertising applicable for that language, locale or geographical area. Alternatively or additionally, in some environments it is possible to derive the physical location of the printer from its network address and so advertising can be selected based on that physical location. Also GPS or GSM technologies can be used to identify the location of a printer by including a corresponding GPS or GSM device in the printer or in a cartridge.

As yet another example, analysis of the words used on real pages or documents printed on the printer may be used to select specific advertising.

Alternatively, or additionally, the user may be invited to select specific categories in which they are interested, through a variety of interfaces (e.g. within printer driver, or through a web site). To encourage users to supply such data the frequency of advertisement printed may be reduced once it has been given; the greater value of better focused advertising will often more than outweigh the reduction in the number of advertisements.

In some embodiments, only one of the methods of focusing the advertising described above is used. In other embodiments, multiple methods, or all of the methods describe above, are used.

In some embodiments, a chip or other device in the cartridge will modify how frequently advertising is provided. The printer will function correctly when using a cartridge that does not contain a chip and advertising will be printed according to pre-set options. When used with a cartridge that does contain a chip the amount or type of advertising may be increased or decreased. In some of these embodiments, a vendor may choose to sell cartridges with chips, optionally containing a variety of options regarding advertising, and cartridges with no chips at all. A chipless cartridge may be provided at a lower price with the disadvantage that it will introduce advertising either on the printed pages or alongside the printing or scanning process, or a chipped cartridge is available at a higher price in order to avoid, or reduce, the advertising that would otherwise be produced.

In alternative embodiments, the printer will function correctly when using a cartridge that does not contain a chip and no advertising will be printed or displayed. If a cartridge containing a chip is used, then advertising will be printed or displayed as controlled by the data in the chip.

The printer and any cartridge chip may communicate, for example, using challenge/response or some other secure or non-secure method of data exchange. Preferably, a secure method of data exchange is used so that the advertising functionality is not easily defeated by third-party cartridge manufacturers.

In at least some embodiments the chip in the cartridge also tracks the number of prints made using that cartridge. When a pre-determined number of prints have been made then it will automatically change the advertising options reported to the printer and the printer driver, increasing the frequency of advertising display and print. The pre-determined number will be set at a slightly larger number of prints than the expected life of the cartridge. This is intended to prevent or reduce the use of re-filled or refurbished cartridges containing chips that suppress advertising from benefiting from that chip.

The methods, systems, and devices described herein may be embodied in many different forms and should not be construed as limited to the embodiments set forth herein. Accordingly, the methods, systems, and devices described herein may take the form of an entirely hardware embodiment, an entirely software embodiment or an embodiment combining software and hardware aspects. The methods described herein can be performed using any type of computing device, such as a computer or printer, that includes a processor or any combination of computing devices where each device performs at least part of the process.

Suitable computing and printer devices typically include mass memory and typically include communication between devices. The mass memory illustrates a type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Methods of communication can include both wired and wireless (e.g., RF, optical, or infrared) communications methods and such methods provide another type of computer readable media; namely communication media. Communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

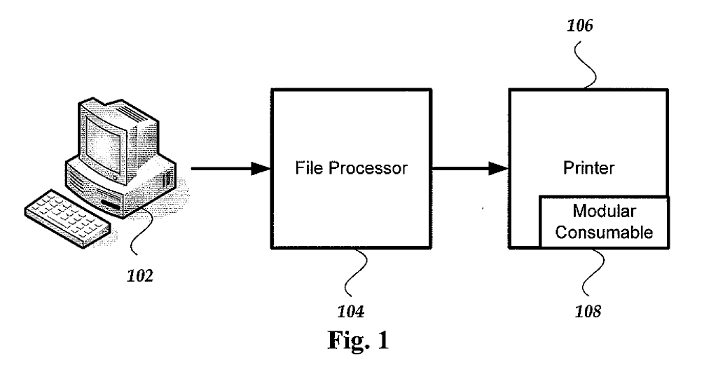

FIG. 1 illustrates one embodiment of a system for printing documents. A computer 102 generates or stores a file to be used in printing the document. The computer 102 includes a printer driver. The file can be provided, using the printer driver, to a file processor 104 (such as a Raster Image Processor (RIP)) to convert the file into a format useable by the printer 106 to print the document. The file processor 104 can be, at least in part, included with the printer 106 or the computer 102 or both.

The printer 106 can be any suitable printing device that uses a modular consumable 108 (e.g., a cartridge for ink, toner, paper, or the like). For example, the printer can be an ink-jet printer or a laser printer.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A system for printing documents, comprising:
a printer;
a replaceable cartridge coupled to the printer and providing a consumable to the printer for printing the documents; and
a printer driver configured and arranged to be disposed on a device coupled to the printer for assisting in providing the documents to the printer,
wherein the system is configured and arranged to print or display advertising to a user in conjunction with the printing of documents.

2. The system of claim 1, wherein the replaceable cartridge comprises a chip, the presence of which modifies the printing or displaying of advertising to the user.

3. The system of claim 2, wherein the system is configured and arranged to increase an amount of advertising printed or displayed to the user if the chip is present in the replaceable cartridge.

4. The system of claim 2, wherein the system is configured and arranged to decrease an amount of advertising printed or displayed to the user if the chip is present in the replaceable cartridge.

5. The system of claim 1, wherein the system is configured and arranged to print the advertising to the user.

6. The system of claim 5, wherein the system is configured and arranged to print the advertising on pages of a print job.

7. The system of claim 5, wherein the system is configured and arranged to print the advertising after a predetermined number of pages have been printed.

8. The system of claim 1, wherein the printer comprises a display panel and the system is configured and arranged to display the advertising on the display panel of the printer.

9. The system of claim 1, wherein the system is configured and arranged to provide the advertising to a device from which a document is received for display of the advertising on that device.

10. The system of claim 1, wherein the advertising is targeted to a projected type of user of the printer.

11. A method of printing a print job, the method comprises:
receiving a print job to print from a user;
printing the print job; and
providing advertising to the user in conjunction with printing the print job.

12. The method of claim 11, wherein providing advertising comprises printing the advertising with the print job.

13. The method of claim 12, wherein printing the advertising comprises printing the advertising on additional pages with the print job.

14. The method of claim 12, wherein printing the advertising comprising printing the advertising in a margin of at least one page of the print job.

15. The method of claim 11, wherein providing advertising comprises displaying the advertising on a display panel of a printer.

16. The method of claim 11, wherein providing advertising comprises displaying the advertising on a display of computer.

17. The method of claim 11, wherein providing advertising comprises determining how often to provide advertising using a chip disposed in a cartridge of a printer that is printing the print job.

18. The method of claim 11, wherein providing advertising comprises selecting advertising from available advertising content based, at least in part, on a geographic location of a printer printing the print job.

19. The method of claim 11, wherein providing advertising comprises requesting, from the printer, and receiving, at the printer, advertising from a source external to the printer or a cartridge disposed in the printer.

20. The method of claim 19, wherein requesting and receiving advertising comprises requesting, from the printer, and receiving, at the printer, advertising from an external source through the Internet.
